(19) United States
(12) Patent Application Publication
(10) Pub. No.: US 2005/0086386 A1
(43) Pub. Date: Apr. 21, 2005

(54) Shared running-buffer-based caching system

(76) Inventors: Bo Shen, Mountain View, CA (US); Songqing Chen, Williamsburg, VA (US); Yong Yan, Fremont, CA (US); Sujoy Basu, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/687,997

(22) Filed: Oct. 17, 2003

(51) Int. Cl. G06F 15/16

(52) U.S. Cl. 709/249; 709/203; 709/219

(57) ABSTRACT

A server-proxy-client network delivers web content objects from servers to clients from cache content at a proxy server in between. Multiple, moving-window buffers are used to service content requests of the server by various independent clients. A first request for content is delivered by the server through the proxy to the requesting client. The content is simultaneously duplicated to a first circulating buffer. Once the buffer fills, the earlier parts are automatically deleted. The buffer therefore holds a most-recently delivered window of content. If a second request for the same content comes in, a check is made to see if the start of the content is still in the first buffer. If it is, the content is delivered from the first buffer. Otherwise, a second buffer is opened and both buffers are used to deliver what they can simultaneously. Such process can open up third and fourth buffers depending on the size of the content, the size of the buffers, and the respective timing of requests.

### FIELD OF THE PRESENT INVENTION

The present invention relates generally to computer network systems and software for delivering objects from servers to clients with shared buffers, and specifically to a caching system based on shared running buffers.

### BACKGROUND OF THE INVENTION

The building block of a content delivery network is a server-proxy-client system. A server delivers content to a client through a proxy. The proxy can choose to cache content objects so that a subsequent request to the same content object can be served directly from the proxy without the delay in contacting the server. Proxy caching strategies have therefore been the focus of many developments, particularly the caching of static web content to reduce network loading and end-to-end latencies.

The caching of larger objects, such as streaming media content, presents a different set of challenges. The size of a streaming media content object is usually orders of magnitude larger than a traditional web content object. For example, a two hour long MPEG video requires approximately 1.4 GB of disk space, while traditional web content may only require 10 KB. The demand of continuous and timely delivery of a streaming media content object is more rigorous than that of traditional text-based web content. Therefore a lot of resources need to be reserved for delivering streaming media data to clients. In practice, even a relatively small number of streaming media clients can overload a media server, creating bottlenecks by demanding high disk bandwidth on the server and requiring high network bandwidth.

A number of caching systems have been proposed that are suited to streaming media and other large objects. Such systems include partial caching, patching, and proxy buffering. Partial caching caches either a prefix or segments of an content object, rather than the whole content object, so less storage space is required. Typically this involves storing the cached data on disk storage on a proxy server. While this does lessen the disk bandwidth requirement on the server, it moves some of that burden to the proxy. Ideally data should be cached in memory to effectively reduce disk bandwidth requirements and reduce data delivery latency. Partial caching techniques are not able to serve the same data to separate overlapping sessions.

For on-going streaming sessions, patching can be used so that later sessions for the same content object can be served simultaneously. A single session may be served to multiple clients at once. A number of sessions for a single content object may be occurring concurrently and a client can receive data from each of these sessions simultaneously, each session providing a different part of the content object. Such requires the clients to be listening on multiple channels and to store content before its presentation time. Thus client side storage is necessary. While patching allows streaming sessions that are overlapped in time to share data it does not buffer data for those sessions and hence does not make the best use of the data retrieved.

Proxy buffering uses either a running buffer or an interval caching buffer. A running buffer is used to store a sliding window of an on-going streaming session in the memory of the proxy. Closely followed requests for the content object can be served directly from the buffer in memory rather than re-fetching the content object for every request. Interval caching is similar but does not allocate a buffer until a further request for an content object is made within a certain timeframe. The prefix of the content object is then retrieved from the server and served to the client in conjunction with the data in the newly created buffer. While both of these techniques use memory to buffer the data, they do not fully use the currently buffered data to optimally reduce server load and network traffic. For example multiple running buffers for the same content object may co-exist in a given processing period without any data sharing among the multiple buffers.

### SUMMARY OF THE PRESENT INVENTION

A server-proxy-client network embodiment of the present invention delivers web content objects from servers to clients from cache content at a proxy server in between. Multiple, moving-window buffers are used to service content requests of the server by various independent clients. A first request for content is delivered by the server through the proxy to the requesting client. The content is simultaneously duplicated to a first circulating buffer. Once the buffer fills, the earlier parts are automatically deleted. The buffer therefore holds a most-recently delivered window of content. If a second request for the same content comes in, a check is made to see if the start of the content is still in the first buffer. If it is, the content is delivered from the first buffer. Otherwise, a second buffer is opened and both buffers are used to deliver what they can simultaneously. Such process can open up third and fourth buffers depending on the size of the content, the size of the buffers, and the respective timing of requests.

### DESCRIPTION OF THE DRAWINGS

FIG. 1 is a schematic diagram of a server-proxy-client network system embodiment of the present invention;

FIG. 2 is a chart of media position against access time, illustrating an embodiment of the present invention;

FIG. 3 is a further chart of media position against access time, illustrating an embodiment of the present invention;

FIG. 4 is a further chart of media position against access time, illustrating an embodiment of the present invention;

FIG. 5 is another chart of media position against access time, illustrating another embodiment of the present invention; and

FIG. 6 is a flowchart diagram of a software embodiment of the present invention.

### DETAILED DESCRIPTION OF THE EMBODIMENTS

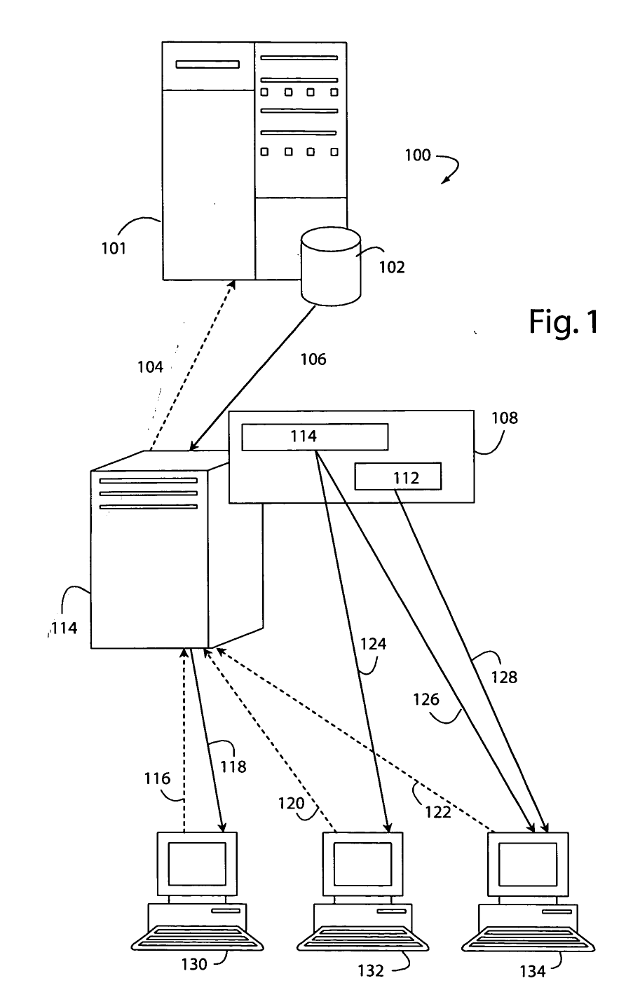

FIG. 1 illustrates a server-proxy-client network system embodiment of the present invention for delivering objects from servers to clients, and is referred to herein by the general reference numeral 100. A server 101 includes original storage of a web content object 102. A request 104 is received for some or all of content object 102, and such is serviced by a response datastream 106. A cache memory 108 includes many recirculating buffers, as represented by a first buffer 110 and a second buffer 112. A proxy server 114 hosts the cache memory 108 and off-loads work from server 101. The buffers 110 and 112 receive copies of the content passing through from the server to any of clients 116-118. Such copies are then available to service subsequent requests for the same content.

Each of clients 116-118 are able to formula content requests and service responses 120-126. Here, a request 120 is responded to directly from server 101 and response 106 by datastream 121. A copy of the response 106 is copied to buffer 110. A request 122 by client 117 for the same content can thus be serviced from buffer 110 with datastream 123. A later request 124 from client 118 is responded to in two datastreams 125 and 126, because the content object being sought is not complete in either buffer 110 or 112.

Because the clients can receive different parts of the content object as separate streams, each client needs to be able to maintain multiple connections to receive the individual streams. In the case of streaming media, the client will need to store content before its presentation time and will therefore store some of the received data.

In a preferred embodiment embodiments of the present invention utilizes the memory space available on a proxy to serve streaming media content more efficiently. When a request for a streaming media content object arrives, if the request is the first to the content object, an initial buffer of size T is allocated. The buffer is capable of caching T time units of content. The buffer is filled with the stream from the server while the same stream is being delivered to the client. Within the next T time units, before the buffer is full, additional requests to the same media content object are served directly from the buffer. At time T the initial buffer is full and based on the current access pattern the buffer may be extended or shrunk.

At some stage the size of the initial buffer is frozen and subsequent requests for the media content object cannot be served completely from the initial buffer. In this case a new buffer of initial size T is allocated and goes through the same adaptive allocation as above. Subsequent requests are served simultaneously from the new buffer as well as its preceding running buffers.

Buffer management is based on user access patterns for particular objects. A request arrival is the time at that a client requests an content object. A request interval is the difference in time between two consecutive requests arrivals.

The average request interval is used to measure the user access pattern. The average request interval is the average request interval between the first request arrival and the last request arrival over the time period that a given number of initial requests arrive. The waiting time is also considered. The waiting time is calculated at time T and is the difference between T and the arrival time of the immediate previous request.

During the lifecycle of a buffer it may be in one of three states, the construction state, the running state or the idle state. When an initial buffer is allocated upon the arrival of an initial request, the buffer is filled while the request is being served, expecting that the data cached in the buffer could serve closely followed requests for the same content object. The size of the buffer may be adjusted to cache less or more data before its size is frozen. Before the buffer size is frozen, the buffer is in the construction state.

The start time of a buffer is defined as the arrival time of the last request before the buffer size is frozen. The requests arriving while a buffer is in the construction state are called the resident requests of this buffer and the buffer is called the resident buffer of these requests.

After the buffer freezes its size it serves as a running window of a streaming session and moves along with the streaming session. Therefore, the state of the buffer is called the running state.

The running distance of a buffer is defined as the length of the content object for the initial buffer allocated for the content object, or for a subsequent buffer as the distance in time between the start time of the buffer and the start time of its preceding buffer. Since data is shared among buffers, clients served from a particular buffer are also served from any preceding buffers that are still in running state. Such requires that the running distance of the buffer equals the time difference with the closest preceding buffer in running state.

When the running window reaches the end of the streaming session, the buffer enters the idle state, that is a transient state that allows the buffer to be reclaimed.

The end time of a buffer is defined as the time when a buffer enters the idle state and is ready to be reclaimed. The end time of the initial buffer is equal to its start time plus the length of the content object assuming a complete viewing scenario. For a subsequent buffer, the end time is the lesser of the start time of the latest running buffer plus the running distance of the subsequent buffer and the start time of the subsequent buffer plus the length of the content object. The end time of the current buffers for an content object is dynamically updated upon the forming of new buffers for that content object.

For an incoming request to an content object, if the latest running buffer of the content object is caching the prefix of the content object, the request is served directly from all the existing running buffers of the content object. Otherwise, if there is enough memory, a new running buffer of a predetermined size T is allocated. The request is served from the new running buffer and all existing running buffers of the content object. If there is not enough memory the request may be served without caching, or a buffer replacement algorithm may be invoked to re-allocate an existing running buffer to the request. The end times of all existing buffers of the content object are then updated.

Initially, all buffers are allocated with a predetermined size. Starting from the construction state, each buffer then adjusts its size by going through a three-state lifecycle management process as described below.

While the buffer is in the construction state, at the end of T, if there has only been one request arrival so far, the initial buffer enters the idle state immediately. For this request, the proxy acts as a bypass server, i.e., content is passed to the client without caching in the memory buffers. Such scheme gives preference to more frequently requested objects in the memory allocation.

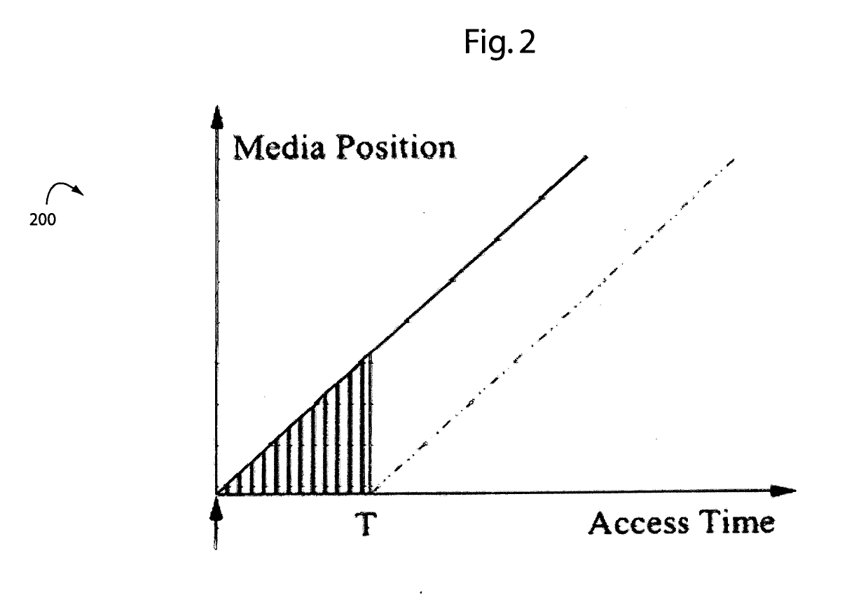

In FIG. 2, the shadow indicates an allocated initial buffer that is reclaimed at T. If there have been multiple requests the waiting time and the average request interval are calculated. If the waiting time is greater than the average request interval, the initial buffer is shrunk by a time value equal to the waiting time, so that the most recent request can be served from the buffer.

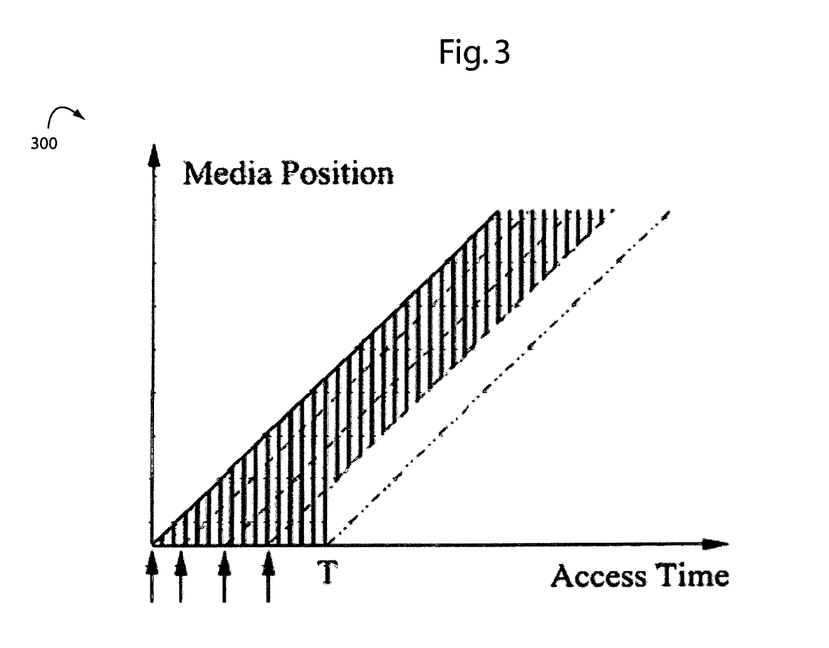

In FIG. 3, part of the initial buffer is reclaimed at the end of T so that the last request, R4 can be served from the buffer. Subsequently, the buffer enters the running state. Such running buffer then serves as a shifting window and runs to its end time. If the waiting time is less than the average request interval, the initial buffer maintains the construction state and is expanded by the difference between the waiting time and the average request interval to T′ expecting that a new request will arrive very soon. At T′ the waiting time and the average request interval are recalculated and the above procedure is repeated.

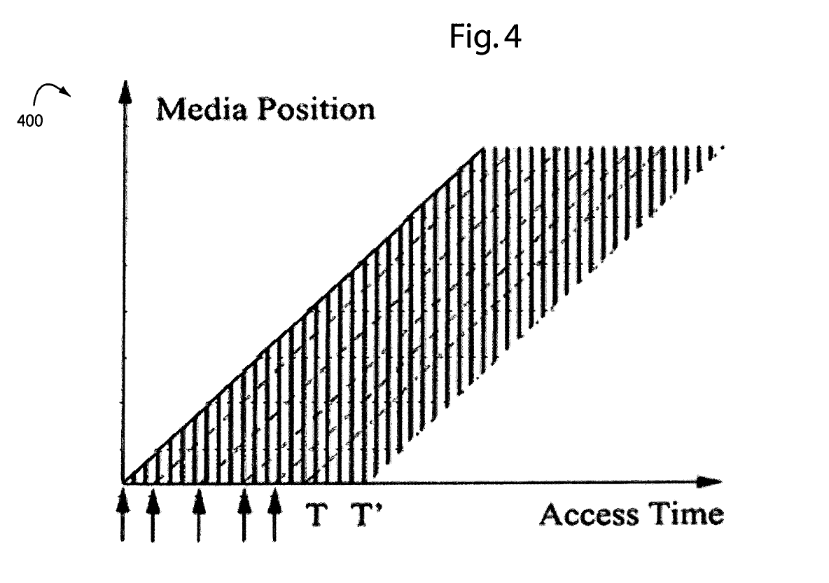

In FIG. 4, the initial buffer has been extended from T to T′. Eventually, when the requests to the content object become less frequent, the buffer will freeze its size and enter the running state. In the extreme case, the full length of the media content object is cached in the buffer. In this case, the buffer also freezes and enters the running state, a static running. For most frequently accessed objects, this scheme ensures that the requests to these objects are served from the proxy memory directly.

The buffer expansion is bounded by the available memory in the proxy. When the available memory is exhausted, the buffer freezes its size and enters the running state regardless of future request arrivals.

After a buffer enters the running state, it starts running away from the beginning of the media content object and subsequent requests can not be served completely from the running buffer. In this case, a new buffer of an initial size T is allocated and goes through its own lifecycle. Subsequent requests are served from the new buffer as well as its preceding running buffers.

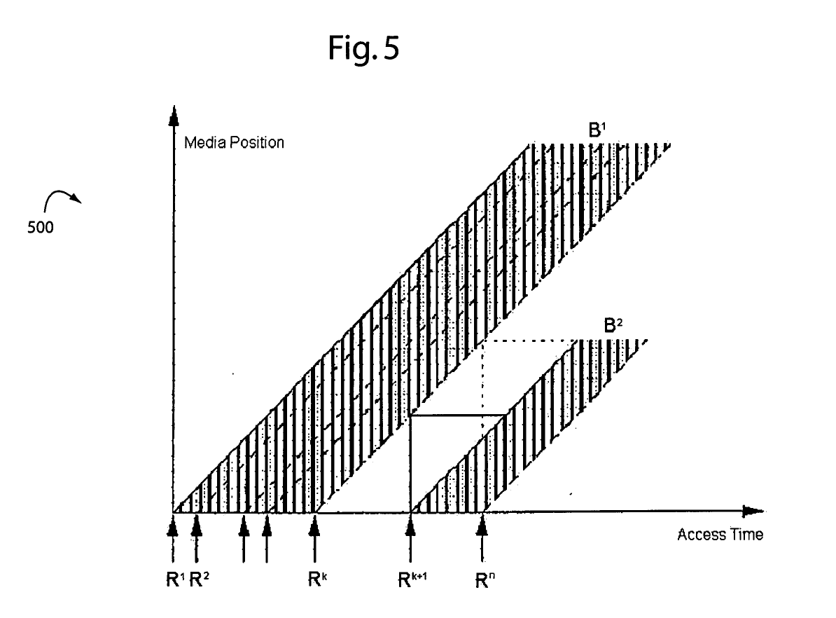

FIG. 5 illustrates maximal data sharing. Requests R1 to Rk are served entirely from the first buffer B1. The requests Rk+1 to Rn are served simultaneously from B1 and B2, showing how late requests are served from all existing buffers. Note that except for the first buffer, the other buffers do not run to the end of the content object.

When a buffer enters the running state, the running distance and end time are calculated for that buffer. In addition, the end times of preceding buffers for the same content object need to be modified according to the arrival time of the latest request. When a buffer runs to its end time, it enters the idle state where it is ready for reclamation.

A running buffer serves a group of requests. All the requests share the data read by the first request in the group. All the requests served by a later running buffer also accept data from earlier running buffers. In addition, the later running buffer only needs to reach the end of its immediate preceding runs at that instant. Since requests served by the later running buffer are also served by earlier runs of the same stream, the earlier runs may need to extend their running distance to cover the gap between different runs. Such means that the content in memory is shared by as many clients as possible, thus reducing disk and network input-output.

In a preferred embodiment, the initial size T of the buffers used for a particular content object is dependent on the advertised length of that content object, generally with a minimum and maximum size for the buffer. For example, a streaming media content object with a running time of one hour may use a buffer of one third that size, e.g., a buffer that will hold twenty minutes worth of streaming content. Such size may then be adjusted according to the user access patterns as described above.

Some embodiments of the present invention reclaim memory that is no longer needed to conserve memory. The delivery of a streaming media content object from initial request to completion or termination is referred to herein as a streaming session. When such a session terminates before it reaches the end of the requested content object, the running buffer can be reclaimed. If the terminated session is served from the head of a running buffer, the system reclaims the memory space from the head of the buffer to the buffer location where the next immediate session is served. If the terminating session is served from the tail of a running buffer, the system reclaims the memory space from the tail up to its immediate prior session immediately or after a time period, depending on whether there are other requests associated with it. If the terminating session is served from the middle of a running buffer, the session is terminated with no buffer space reclaimed.

When there is memory released from the running buffers because of normal session termination, the newly available memory can be allocated to serve the requests to the most popular content object that needs a buffer.

Embodiments of the present invention may incorporates a buffer replacement algorithm. The replacement algorithm is important in the sense that the available memory is still scarce compared to the size of video objects, so to efficiently use the limited resources is critical to achieve the best performance gain. One embodiment implements a popularity-based replacement algorithm. If a request arrives while there is no available memory, all the objects that have on-going streams in memory are ordered according to their popularities calculated over a certain past time period.

If the content object being demanded has a higher popularity than the least popular content object in memory, then the latest running buffer of the least popular content object is released, and the space is re-allocated to the new request. Those requests without running buffers do not buffer their data at all. In this case, theoretically, they are assumed to have no memory consumption. Alternatively, the system can choose to start a memory less session in that the proxy bypasses the content to the client without caching. Such is called a non-replacement policy.

In an alternative embodiment, a zero-sized buffer may be used that results in a bypass session that can be shared. A bypass session is one in that the content is streamed directly to the client without caching or additional action. If a later request to the same content object can listen to this bypass session, only the prefix of the content object needs to be delivered to the later request.

A method embodiment of the present invention comprises receiving a first request for an content object. An initial running buffer of a predetermined size is allocated to store a first amount of data from the content object. The content object is retrieved as a datastream having a start point and inserting the datastream into the initial buffer while delivering the same datastream. When the initial buffer is filled, data is deleted from the start of the datastream while continuing to insert retrieved data into the buffer. The buffer contains a moving window of the retrieved data. A second request is received. If such is received while the start of the datastream is in the initial buffer, the content object is served directly from the initial buffer. If the second request is received after the start point has been deleted from the initial buffer, the portion of the content object that has been deleted from the initial buffer is fetched, commencing from the start point. Such is delivered simultaneously with other parts of the content object from the initial buffer.

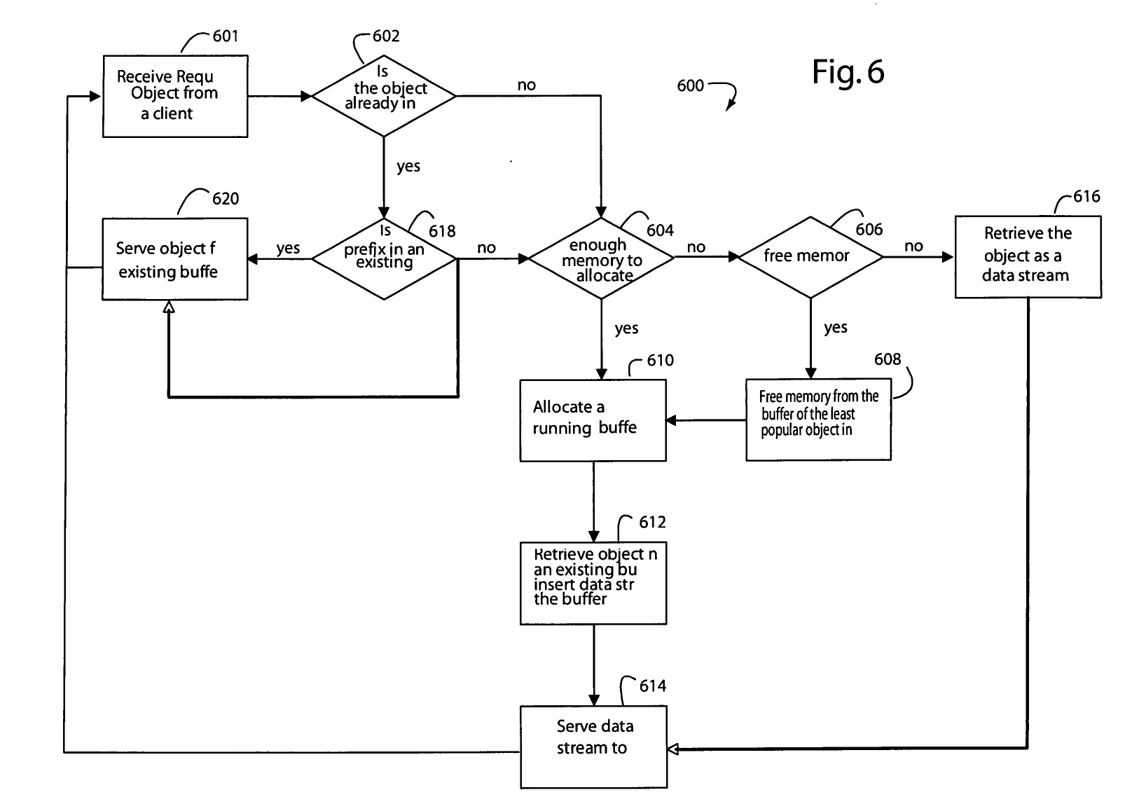

Referring now to FIG. 6, embodiments of the present invention can be embodied in computer software to perform the following functions. A request 600 is received from a client for an content object. A check is made to see if the content object is currently in an existing buffer 601. If the content object is not in an existing buffer then this is an initial request for the content object that will require the content object to be retrieved, and preferably buffered. A check is made to determine whether there is enough memory to allocate a new buffer 602. If there is not enough memory to allocate a new buffer, a process 603 is run to determine whether memory can be freed from any buffers existing for other objects. If memory can be freed, a process 604 determines the least popular content object in memory, and reclaims the latest buffer for that content object to make room for the new buffer. The new buffer is then allocated 605 to store a sliding window of data from the requested content object. A process 606 retrieve the content object as a datastream and inserts the datastream into the newly allocated buffer while at the same time delivering the datastream to the client 607.

If process 603 determines that memory is not available and cannot be reclaimed from other buffers, then a pass-through session is required that does not buffer the data. A process 608 retrieves the content object as a datastream and the datastream is delivered directly to the client 607.

If step 601 determines that the content object is already in an existing buffer then this request is a further request for the content object, and the content object will be able to be served either fully or partially from any existing buffers for the content object. A process 609 checks to see if the prefix of the content object is in an existing buffer. If the prefix is cached then due to the sliding nature of the buffers the whole content object should be in the existing buffers. In this case process 610 serves the content object to the client from all of the existing buffers. The content object may be in one or more buffers. If the content object is in more than one buffer then the client will be required to maintain separate connections to retrieve data, representing different parts of the content object, from each of the buffers.

If step 609 determines that the prefix is not being cached in an existing buffer then part of the content object must be retrieved before serving while other parts of the content object can be served directly from any buffers existing for the content object. Process 610 proceeds to serve the content object to the client for all of the existing buffers while step 602 checks to see whether there is enough room to allocate a new buffer. If there is not enough memory to allocate a new buffer, a process 603 is run to determine whether memory can be freed from any buffers existing for other objects. If memory can be freed, a process 604 determines the least popular content object in memory, and reclaims the latest buffer for that content object to make room for the new buffer. The new buffer is then allocated 605 to store a sliding window of data from the requested content object. A process 606 retrieves the content object as a datastream and inserts the datastream into the newly allocated buffer while at the same time delivering the datastream to the client 607. Such datastream is delivered in parallel with the data delivered by process 610.

If process 603 determines that memory is not available and cannot be reclaimed from other buffers, then a pass-through session is required that does not buffer the data. A process 608 retrieves the content object as a datastream and is delivered directly to the client 607. Such datastream is delivered in parallel with the data delivered by process 610.

Because parts of the content object already exist in one or more other buffers, processes 606 and 608 only need to retrieve the prefix of the content object, e.g., from the beginning, up to the nearest part already in an existing buffer. Such results in the content object in memory being shared by as many clients as possible reducing disk and network loading.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the present invention.

1. A network proxy server, comprising:
a network connection able to intercept content-object requests of clients from a server, and able to respond instead of said server to such; and
a plurality of content buffers for duplicating web content passing through from said server to any client, and for caching such web content to any subsequent clients;
wherein, multiple, moving-window buffers are included in the plurality of content buffers to service content requests of a server by various independent clients; and
wherein, whole requests for content-object from single clients can be serviced simultaneously from parts distributed across more than one such content buffer.

2. A system of delivering objects from servers to clients comprising:
receiving a first request for an content object from a first client;
allocating a first running buffer;
retrieving the content object as a datastream having a start point and inserting the datastream into the first buffer while delivering the same datastream to the first client;
when the first buffer is filled, deleting data from the start point of the datastream while continuing to insert retrieved data into the buffer, so that the buffer contains a moving window of the retrieved data;
receiving a second request for the content object from a client;
if the second request is received while the start point of the datastream is still in the first buffer, serving the content object directly from the first buffer; and
if the second request is received after the start point has been deleted from the first buffer, retrieving the portion of the content object that has been deleted from the first buffer, commencing from the start point, and delivering the same as a datastream while simultaneously delivering a different part of the content object from the first buffer.

3. The system of claim 2, further comprising, if the second request is received after the start point of the datastream has been deleted from the first buffer:
allocating a second running buffer and inserting the datastream representing the portion of the content object not in the first running buffer into the second running buffer while delivering the same datastream.

4. The system of claim 3 further comprising for a third request for the content object received after the second running buffer has been allocated;
checking whether the start point is cached in an existing running buffer;
if the start point is cached in an existing running buffer, serving the content object as a datastream from each of the running buffers simultaneously;
if the start point is not cached in an existing running buffer,
allocating a third running buffer;
retrieving the portion of the content object not in an existing running buffer as a datastream and inserting the datastream into the third running buffer while delivering the same datastream and simultaneously delivering a different part of the content object from other existing running buffers.

5. The system of claim 2, wherein the first buffer or another buffer has a size that is determined as a proportion of an advertised length of the content object.

6. The system of claim 2, further comprising:
modifying the size of the first buffer or another buffer in response to an analysis of frequency of requests for the content object, in order to optimize allocation of memory.

7. The system of claim 2, further comprising, prior to allocating the first buffer or another buffer, applying a replacement algorithm to reclaim buffers from less frequently requested objects.

8. The system of claim 2, wherein the content object has a time length L and each buffer has a start time Sᵢ, an end time Eᵢ and a running distance Dᵢ, wherein the running distance Dᵢ for each buffer after the first buffer equals: Dᵢ=Sᵢ−Sᵢ₋₁, and wherein the end time Eᵢ for each buffer after the first buffer is, Eᵢ=min(Sₗₐₜₑₛₜ+Dᵢ, Sᵢ+L), where, Sₗₐₜₑₛₜ is the start time of the most recent buffer allocated.

9. Computer data storage media having stored thereon software performing the following functions:
receiving a first request for an content object;
allocating a first running buffer;
retrieving the content object as a datastream having a start point and inserting the datastream into the first buffer while delivering the same datastream;
when the first buffer is filled, deleting data from the start point of the datastream while continuing to insert retrieved data into the buffer, so that the buffer contains a moving window of the retrieved data;
receiving a second request for the content object;
if the second request is received while the start point of the datastream is in the first buffer, serving the content object directly from the first buffer;
if the second request is received after the start point has been deleted from the first buffer:
retrieving the portion of the content object that has been deleted from the first buffer, commencing from the start point, and delivering the same as a datastream while simultaneously delivering a different part of the content object as a datastream from the first buffer.

10. The computer data storage media of claim 9, wherein the software performs the following further functions:
if the second request is received after the start point of the datastream has been deleted from the first buffer, allocating a second running buffer and inserting the datastream representing the portion of the content object not in the first running buffer into the second running buffer while delivering the same datastream.

11. The computer data storage media of claim 9, wherein the software performs the following further functions:
receiving a third request for the content object after the second running buffer has been allocated;
checking whether the start point is cached in an existing running buffer;
if the start point is cached in an existing running buffer, serving the content object as a datastream from each of the running buffers simultaneously;
if the start point is not cached in an existing running buffer:
allocating a third running buffer;
retrieving the portion of the content object not in an existing running buffer as a datastream and inserting the datastream into the third running buffer while delivering the same datastream and simultaneously delivering a different part of the content object as a datastream from other existing running buffers.

12. The computer data storage media of claim 9, wherein the software performs the following further functions:
determining the advertised length of the content object;
setting the size of the first buffer or another buffer as a proportion of an advertised length of the content object.

13. The computer data storage media of claim 9, wherein:
analyzing frequency of requests for the content object; and
modifying the size of the first buffer or another buffer in response to the analysis of the frequency of requests for the content object in order to optimize allocation of memory.

14. The computer data storage media of claim 9, wherein:
prior to allocating the first buffer or another buffer checking if memory is available;
if there is not enough memory available to allocate a buffer, applying a replacement algorithm to reclaim buffers from less frequently requested objects.

15. The computer data storage media of claim 9, wherein:
determining a time length L for the content object;
setting a start time Sᵢ, an end time Eᵢ and a running distance Dᵢ for each buffer;
computing the running distance Dᵢ for each buffer after the first buffer as, Dᵢ=Sᵢ−Sᵢ₋₁;
computing the end time Eᵢ for each buffer after the first buffer as, Eᵢ=min(Sₗₐₜₑₛₜ+Dᵢ, Sᵢ+L) , where, Sₗₐₜₑₛₜ is the start time of the most recent buffer allocated.
